(19) United States
(12) Patent Application Publication
(10) Pub. No.: US 2013/0078176 A1
(43) Pub. Date: Mar. 28, 2013

(54) FLOW TUBE REACTOR FOR CONVERSION OF SILICON TETRACHLORIDE TO TRICHLOROSILANE

(71) Applicants: Guido Stochniol, Haltern am See (DE); Guenter Latoschinski, Marl (DE); Yuecel Oenal, Carl Junction, MO (US); Ingo Pauli, Schmitten (DE); Alfons Bieker, Wehr (DE)

(72) Inventors: Guido Stochniol, Haltern am See (DE); Guenter Latoschinski, Marl (DE); Yuecel Oenal, Carl Junction, MO (US); Ingo Pauli, Schmitten (DE); Alfons Bieker, Wehr (DE)

(73) Assignee: Evonik Degussa GmbH, Essen (DE)

(21) Appl. No.: 13/521,638

(22) PCT Filed: Dec. 15, 2010
(86) PCT No.: PCT/EP2010/069799

§ 371 Date: Nov. 21, 2012

(30) Foreign Application Priority Data
Jan. 18, 2010 (DE) 10 2010 000 978.4

(51) Int. Cl. C01B 33/107; B01J 19/00

(52) U.S. Cl. CPC C01B 33/10773; B01J 19/0053
USPC 423/342; 422/240; 422/187

(57) ABSTRACT

The invention relates to a method for converting silicon tetrachloride having hydrogen to trichlorosilane in a hydrodechlorination reactor, wherein the hydrodechlorination reactor is operated under pressure and comprises one or more reactor tubes which are made of a ceramic material. The invention further relates to the use of such a hydrodechlorination reactor as an integral component of a system for producing trichlorosilane from metallurgical silicon.

The invention relates to a process for reacting silicon tetrachloride with hydrogen to give trichlorosilane in a hydrodechlorination reactor which is operated under pressure and comprises one or more reactor tubes consisting of ceramic material. The invention further relates to the use of such a hydrodechlorination reactor as an integral part of a plant for preparing trichlorosilane from metallurgical silicon.

In many industrial processes in silicon chemistry, SiCl₄ and HSiCl₃ form together. It is therefore necessary to interconvert these two products and hence to satisfy the particular demand for one of the products.

Furthermore, high-purity HSiCl₃ is an important feedstock in the production of solar silicon.

In the hydrodechlorination of silicon tetrachloride (STC) to trichlorosilane (TCS), the industrial standard is the use of a thermally controlled process in which the STC is passed together with hydrogen into a graphite-lined reactor, known as the “Siemens furnace”. The graphite rods present in the reactor are operated in the form of resistance heating, such that temperatures of 1100° C. and higher are attained. By virtue of the high temperature and the hydrogen component, the equilibrium position is shifted toward the TCS product. The product mixture is conducted out of the reactor after the reaction and removed in complex processes. The flow through the reactor is continuous, and the inner surfaces of the reactor must consist of graphite, being a corrosion-resistant material. For stabilization, an outer metal shell is used. The outer wall of the reactor has to be cooled in order to very substantially suppress the decomposition reactions which occur at the high temperatures at the hot reactor wall, and which can lead to silicon deposits.

In addition to the disadvantageous decomposition owing to the necessary and uneconomic very high temperature, the regular cleaning of the reactor is also disadvantageous. Owing to the restricted reactor size, a series of independent reactors has to be operated, which is economically likewise disadvantageous. The present technology does not allow operation under pressure in order to achieve a higher space-time yield, in order thus, for example, to reduce the number of reactors.

A further disadvantage is the performance of a purely thermal reaction without a catalyst, which makes the process very inefficient overall.

It was thus an object of the present invention to provide a process for reacting silicon tetrachloride with hydrogen to give trichiorosilane, which works more efficiently and can achieve a higher conversion with comparable reactor size, i.e. increases the space-time yield of TCS. Furthermore, the process according to the invention should enable a high selectivity for TCS.

The problem has been solved by finding that a mixture of STC and hydrogen can be conducted through a pressurized tubular reactor which may preferably be equipped either with a catalytic wall coating or with a fixed bed catalyst. The combination of the use of a catalyst for improving the reaction kinetics and enhancing the selectivity and a pressurized reaction ensure an economically and ecologically very efficient process regime. By suitable setting of the reaction parameters, such as pressure, residence time, ratio of hydrogen to STC, it is possible to implement a process in which high space-time yields of TCS are obtained with a high selectivity.

The use of a suitable catalyst in conjunction with pressure constitutes a special feature of the process, since it is thus possible to obtain sufficiently high amounts of TCS even at comparatively low temperatures of significantly below 1000° C., preferably below 950° C., without having to accept significant losses as a result of thermal decomposition.

In this context, it has been found that it is possible to use particular ceramic materials for the reaction tubes of the reactor, since they are sufficiently inert and ensure the pressure resistance of the reactor even at high temperatures, for example 1000° C., without the ceramic material, for example, being subject to a phase conversion which would damage the structure and hence adversely affect the mechanical durability. In this context, it is necessary to use gas-tight tubes. Gas-tightness and inertness can be achieved by means of high-temperature-resistant ceramics which are specified in detail below.

The reactor tube material may be provided with a catalytically active inner coating. As an additional measure, the reactor tube may be filled with an inert bed, in order to optimize the flow dynamics. The bed may consist of the same material as the reactor material. The beds used may be random packings, such as rings, spheres, rods, or other suitable random packings. In a particular embodiment, the random packings may additionally be covered with a catalytically active coating. In this case, it is optionally possible to dispense with the catalytically active inner coating.

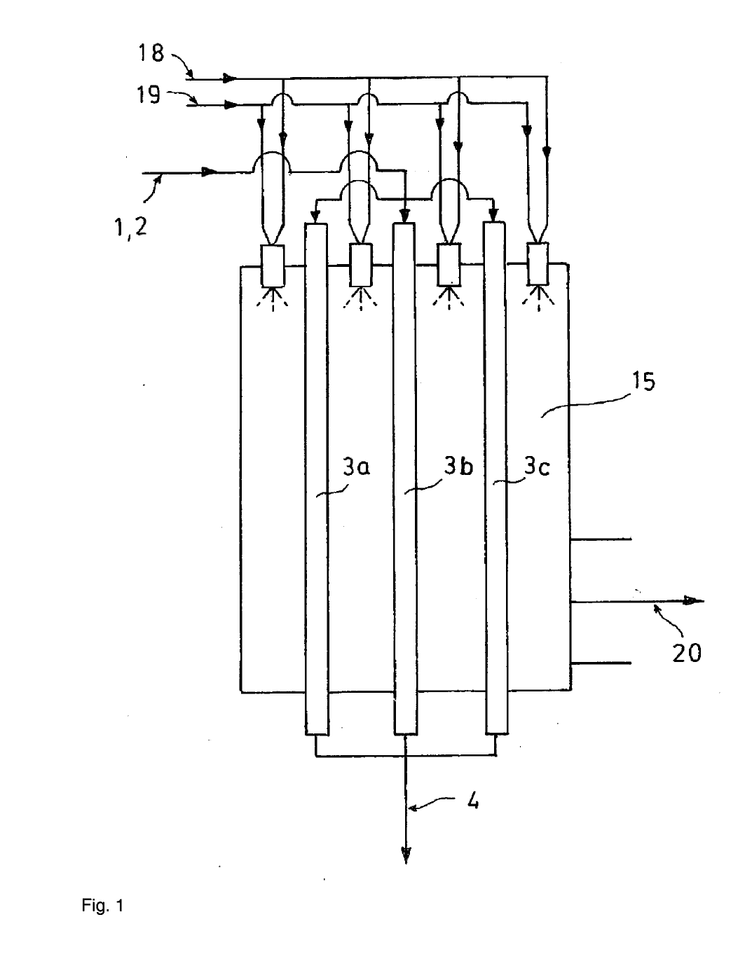

The dimensions of the reactor tube and the design of the complete reactor are determined by the availability of the tube geometry, and by the requirements regarding the introduction of the heat required for the reaction regime. It is possible to use either a single reaction tube with the corresponding periphery or a combination of many reactor tubes. In the latter case, it may be advisable to arrange many reactor tubes in a heated chamber, in which the amount of heat is introduced, for example, by means of natural gas burners. In order to avoid a local temperature peak in the reactor tubes, the burners should not be directed onto the tubes. They may, for example, be aligned into the reactor chamber indirectly from above and be distributed over the reactor chamber, as shown by way of example in FIG. 1. To enhance the energy efficiency, the reactor system may be connected to a heat recovery system.

The inventive achievement of the abovementioned object is described in detail hereinafter, including different or preferred embodiments.

The invention thus provides a process for reacting silicon tetrachloride with hydrogen to give trichlorosilane in a hydrodechlorination reactor, characterized in that the hydrodechlorination reactor is operated under pressure and comprises one or more reactor tubes consisting of ceramic material.

More particularly, the process according to the invention is a process wherein the reaction is that of a silicon tetrachloride-containing reactant gas and a hydrogen-containing reactant gas in a hydrodechlorination reactor by supply of heat to form a trichlorosilane-containing and HCl-containing product gas, characterized in that the silicon tetrachloride-containing reactant gas and/or the hydrogen-containing reactant gas are conducted as pressurized streams into the pressure-operated hydrodechlorination reactor, and the product gas is conducted out of the hydrodechlorination reactor as a pressurized stream. The product stream may possibly also comprise by-products such as dichlorosilane, monochlorosilane and/or silane. The product stream generally also comprises as yet unconverted reactants, i.e. silicon tetrachloride and water.

The equilibrium reaction in the hydrodechlorination reactor is typically performed at 700° C. to 1000 ° C., preferably at 850° C. to 950° C., and at a pressure in the range from 1 to 10 bar, preferably from 3 to 8 bar, more preferably from 4 to 6 bar.

In all variants of the process according to the invention described, the silicon tetrachloride-containing reactant gas and the hydrogen-containing reactant gas can also be conducted as a combined stream into the pressurized hydrodechlorination reactor.

The ceramic material for the one or more reactor tubes is preferably selected from Al₂O₃, AIN, Si₃N₄, SiCN and SiC, more preferably selected from Si-infiltrated SiC, isostatically pressed SiC, isostatically hot-pressed SiC and SiC sintered under ambient pressure (SSiC).

Particularly reactors with SiC-containing reactor tubes are preferred, since they possess particularly good thermal conductivity, which enables homogeneous heat distribution and good heat input for the reaction. It is especially preferred when the one or more reactor tubes consist of SiC sintered under ambient pressure (SSiC).

It is envisaged in accordance with the invention that the silicon tetrachloride-containing reactant gas and/or the hydrogen-containing reactant gas is preferably conducted into the hydrodechlorination reactor with a pressure in the range from 1 to 10 bar, preferably in the range from 3 to 8 bar, more preferably in the range from 4 to 6 bar, and with a temperature in the range from 150° C. to 900° C., preferably in the range from 300° C. to 800° C., more preferably in the range from 500° C. to 700° C.

The heat for the reaction can be supplied in the hydrodechlorination reactor by means of a heating space in which the one or more reactor tubes are arranged. For example, the heating space can be heated by electrical resistance heating. The heating space may also be a combustion chamber which is operated with combustion gas and combustion air.

According to the invention, it is particularly preferred that the reaction in the hydrodechlorination reactor is catalysed by an inner coating which catalyses the reaction in the one or more reactor tubes. The reaction in the hydrodechlorination reactor can additionally be catalysed by a coating which catalyses the reaction on a fixed bed arranged in the reactor or in the one or more reactor tubes. In the case of use of a catalytically active fixed bed, it is possible if desired to dispense with the catalytically active inner coating. However, it is preferable to include the inner wall of the reactor, since the catalytically usable surface area is thus increased compared to purely supported catalyst systems (for example by a fixed bed).

The catalytically active coating(s), i.e. for the inner wall of the reactor and/or any fixed bed used, consist preferably of a composition which comprises at least one active component selected from the metals Ti, Zr, Hf, Ni, Pd, Pt, Mo, W, Nb, Ta, Ba, Sr, Ca, Mg, Ru, Rh, Ir and combinations thereof, and silicide compounds thereof, especially Pt, Pt/Pd, Pt/Rh and Pt/Ir.

The inner wall of the reactor and/or any fixed bed used may be provided with the catalytically active coating as follows:

by providing a suspension, also referred to hereinafter as coating material or paste, comprising a) at least one active component selected from the metals Ti, Zr, Hf, Ni, Pd, Pt, Mo, W, Nb, Ta, Ba, Sr, Ca, Mg, Ru, Rh, Ir and combinations thereof, and silicide compounds thereof, b) at least one suspension medium, and optionally c) at least one auxiliary component, especially for stabilizing the suspension, for improving the storage stability of the suspension, for improving the adhesion of the suspension to the surface to be coated and/or for improving the application of the suspension to the surface to be coated; by applying the suspension to the inner wall of the one or more reactor tubes and, optionally, by applying the suspension to the surface of random packings of any fixed bed provided; by drying the suspension applied; and by heat-treating the applied and dried suspension at a temperature in the range from 500° C. to 1500° C. under inert gas or hydrogen. The heat-treated random packings can then be introduced into the one or more reactor tubes. The heat treatment and optionally also the preceding drying may, however, also be effected with already introduced random packings.

The suspension media used in component b) of the inventive suspension, i.e. coating material or paste, especially those suspension media with binding character (also referred to as binders for short), may advantageously be thermoplastic polymeric acrylate resins as used in the paints and coatings industry. Examples include polymethyl acrylate, polyethyl acrylate, polypropyl methacrylate or polybutyl acrylate. These are systems customary on the market, for example those obtainable under the Degalan® brand name from Evonik Industries.

Optionally, the further components used, i.e. in the sense of component c), may advantageously be one or more auxiliaries or auxiliary components.

For instance, the auxiliary component c) used may optionally be solvent or diluent. Suitable with preference are organic solvents, especially aromatic solvents or diluents, such as toluene, xylenes, and also ketones, aldehydes, esters, alcohols or mixtures of at least two of the aforementioned solvents or diluents.

A stabilization of the suspension can—if required—advantageously be achieved by inorganic or organic rheology additives. The preferred inorganic rheology additives as component c) include, for example, kieselguhr, bentonites, smectites and attapulgites, synthetic sheet silicates, fumed silica or precipitated silica. The organic rheology additives or auxiliary components c) preferably include castor oil and derivatives thereof, such as polyamide-modified castor oil, polyolefin or polyolefin- modified polyamide, and polyamide and derivatives thereof, as sold, for example, under the Luvotix® brand name, and also mixed systems composed of inorganic and organic rheology additives.

In order to achieve an advantageous adhesion, the auxiliary components c) used may also be suitable adhesion promoters from the group of the silanes or siloxanes. Examples for this purpose include—though not exclusively—dimethyl-, diethyl-, dipropyl-, dibutyl-, diphenylpolysiloxane or mixed systems thereof, for example phenylethyl- or phenylbutylsiloxanes or other mixed systems, and mixtures thereof.

The inventive coating material or the paste may be obtained in a comparatively simple and economically viable manner, for example, by mixing, stirring or kneading the feedstocks (cf. components a), b) and optionally c)) in corresponding common apparatus known per se to those skilled in the art. In addition, reference is made to the present inventive examples.

The invention further provides for the use of a hydrodechlorination reactor as an integral part of a plant for preparing trichlorosilane from metallurgical silicon, characterized in that the hydrodechlorination reactor is operated under pressure and comprises one or more reactor tubes which consist of ceramic material. The hydrodechlorination reactor for use in accordance with the invention may be as described above.

The plant for preparing trichlorosilane, in which the hydrodechlorination reactor can preferably be used, comprises:
a) a component plant for reacting silicon tetrachloride with hydrogen to form trichlorosilane, comprising:
   a hydrodechlorination reactor arranged in a heating space or a combustion chamber, the arrangement preferably comprising one or more reactor tubes in a combustion chamber;
   at least one line for silicon tetrachloride-containing gas and at least one line for hydrogen-containing gas, which lead into the hydrodechlorination reactor or the arrangement of one or more reactor tubes, a combined line for the silicon tetrachloride-containing gas and the hydrogen-containing gas optionally being provided instead of separate lines and;
   a line conducted out of the hydrodechlorination reactor for a trichlorosilane-containing and HCl-containing product gas;
   a heat exchanger, which is preferably a tube bundle heat exchanger, through which the product gas line and the at least one silicon tetrachloride line and/or the at least one hydrogen line are conducted such that heat transfer from the product gas line into the at least one silicon tetrachloride line and/or the at least one hydrogen line is possible, the heat exchanger optionally comprising heat exchanger elements made from ceramic material;
   optionally a component plant or an arrangement comprising a plurality of component plants for removing in each case one or more products comprising silicon tetrachloride, trichlorosilane, hydrogen and HCl;
   optionally a line which conducts silicon tetrachloride removed into the silicon tetrachloride line, preferably upstream of the heat exchanger;
   optionally a line, by means of which trichlorosilane removed is fed to an end product removal process;
   optionally a line which conducts hydrogen removed into the hydrogen line, preferably upstream of the heat exchanger; and
   optionally a line, by means of which HCl removed is fed to a plant for hydrochlorinating silicon; and
b) a component plant for reacting metallurgical silicon with HCl to form silicon tetrachloride, comprising:
   a hydrochlorination plant connected upstream of the component plant for reacting silicon tetrachloride with hydrogen, with optional conduction of at least a portion of the HCl used via the HCl stream into the hydrochlorination plant;
   a condenser for removing at least a portion of the hydrogen coproduct which originates from the reaction in the hydrochlorination plant, this hydrogen being conducted via the hydrogen line into the hydrodechlorination reactor or the arrangement of one or more reactor tubes;
   a distillation plant for removing at least silicon tetrachloride and trichlorosilane from the remaining product mixture which originates from the reaction in the hydrochlorination plant, said silicon tetrachloride being conducted via the silicon tetrachloride line into the hydrodechlorination reactor or the arrangement of one or more reactor tubes; and
   optionally a recuperator for preheating the combustion air intended for the combustion chamber with the flue gas flowing out of the combustion chamber; and
   optionally a plant for raising steam from the flue gas flowing out of the recuperator.

FIG. 1 shows, illustratively and schematically, a hydrodechlorination reactor which can be used in accordance with the invention in a process for reacting silicon tetrachloride with hydrogen to give trichlorosilane or as an integral part of a plant for preparing trichlorosilane from metallurgical silicon.

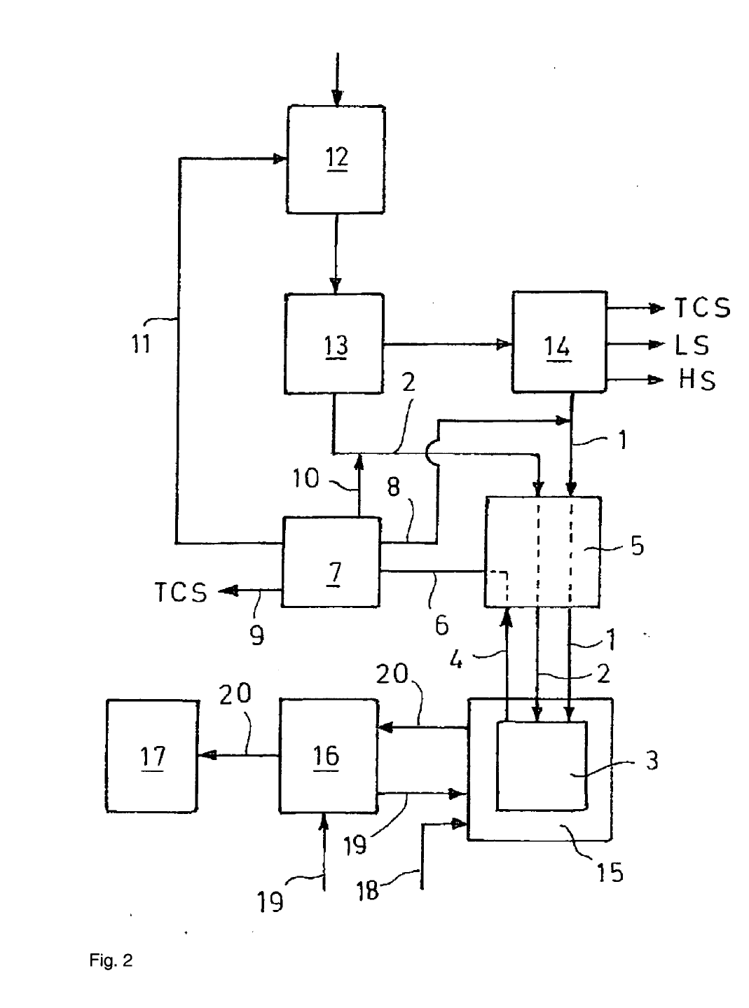

FIG. 2 shows, illustratively and schematically, a plant for preparing trichlorosilane from metallurgical silicon, in which the inventive hydrodechlorination reactor can be used.

The hydrodechlorination reactor shown in FIG. 1 comprises a plurality of reactor tubes 3a, 3b, 3c arranged in a combustion chamber 15, a combined reactant stream 1, 2 which is conducted into the plurality of reactor tubes 3a, 3b, 3c, and a line 4 for a product stream conducted out of the plurality of reactor tubes 3a, 3b, 3c. The reactor shown also includes a combustion chamber 15 and a line for combustion gas 18 and a line for combustion air 19, which lead to the four burners shown in the combustion chamber 15. Also shown, finally, is a line for flue gas 20 which leads out of the combustion chamber 15.

The plant shown in FIG. 2 comprises a hydrodechlorination reactor 3 which is arranged in a combustion chamber 15 and, in accordance with the invention, may comprise one or more reactor tubes 3a, 3b, 3c (not shown). The plant shown comprises a line 1 for silicon tetrachloride-containing gas and a line 2 for hydrogen-containing gas, both of which lead into the hydrodechlorination reactor 3, a line 4 for a trichlorosilane-containing and HCl-containing product gas which is conducted out of the hydrodechlorination reactor 3, and a heat exchanger 5, through which the product gas line 4 and the silicon tetrachloride line 1 and the hydrogen line 2 are conducted, such that heat transfer from the product gas line 4 into the silicon tetrachloride line 1 and into the hydrogen line 2 is possible. The plant further comprises a plant component 7 for removal of silicon tetrachloride 8, of trichlorosilane 9, of hydrogen 10 and of HCl 11. This involves conducting the silicon tetrachloride removed through the line 8 into the silicon tetrachloride line 1, feeding the trichlorosilane removed through the line 9 to an end product removal step, conducting the hydrogen removed through the line 10 into the hydrogen line 2 and feeding the HCl removed through the line 11 to a plant 12 for hydrochlorinating silicon. The plant further comprises a condenser 13 for removing the hydrogen coproduct which originates from the reaction in the hydrochlorination plant 12, this hydrogen being conducted through the hydrogen line 2 via the heat exchanger 5 into the hydrodechlorination reactor 3. Also shown is a distillation system 14 for removing silicon tetrachloride 1 and trichlorosilane (TCS), and also low boilers (LS) and high boilers (HS), from the product mixture, which comes from the hydro-chlorination plant 12 via the condenser 13. The plant finally also comprises a recuperator 16 which preheats the combustion air 19 intended for the combustion chamber 15 with the flue gas 20 flowing out of the combustion chamber 15, and a plant 17 for raising steam with the aid of the flue gas 20 flowing out of the recuperator 16.

### EXAMPLE

Reaction in an inventive reactor: The reaction tube used was an SSiC tube with a length of 1100 mm and an internal diameter of 5 mm.

The reactor tube was placed into an electrically heatable tub furnace. First, the tube furnace containing the particular tube was brought to 900° C., in the course of which nitrogen at 3 bar absolute was passed through the reaction tube. After two hours, the nitrogen was replaced by hydrogen. After a further hour in the hydrogen stream, likewise at 3 bar absolute, 36.3 ml/h of silicon tetrachloride were pumped into the reaction tube. The hydrogen stream was adjusted to a molar excess of 4.2 to 1. The reactor discharge was analysed by online gas chromatography, and this was used to calculate the silicon tetrachloride conversion and the molar selectivity to give trichlorosilane. The only secondary component found was dichlorosilane. The hydrogen chloride formed was not excluded from the calculation and not assessed. The results are shown in table 1.

TABLE 1
Results of the catalytic reaction of STC with hydrogen

| | | | | DCS |
|---|---|---|---|---|
| | Metal | STC conversion | TCS selectivity | selectivity |
| | component | [%] | [%] | [%] |
| Example | SSiC tube | 25.8 | 96.57 | 0.43 |

STC = silicon tetrachloride
TCS = trichlorosilane
DCS = dichlorosilane

### LIST OF REFERENCE NUMERALS

(1) silicon tetrachloride-containing reactant stream
(2) hydrogen-containing reactant stream
(1,2) combined reactant stream
(3) hydrodechlorination reactor
(3a, 3b, 3c) reactor tubes
(4) product stream
(5) heat exchanger
(6) cooled product stream
(7) downstream component plant
(7a, 7b, 7c) arrangement of several component plants
(8) silicon tetrachloride stream removed in (7) or (7a, 7b, 7c)
(9) end product stream removed in (7) or (7a, 7b, 7c)
(10) hydrogen stream removed in (7) or (7a, 7b, 7c)
(11) HCl stream removed in (7) or (7a, 7b, 7c)
(12) upstream hydrochlorination process or plant
(13) condenser
(14) distillation plant
(15) heating space or combustion chamber
(16) recuperator
(17) plant for raising steam
(18) combustion gas
(19) combustion air
(20) flue gas

1. A process, comprising reacting silicon tetrachloride with hydrogen in a hydrodechlorination reactor to produce trichlorosilane, wherein the hydrodechlorination reactor is operated under pressure and comprises a reactor tube comprising a ceramic material.

2. The process of claim 1, comprising reacting a silicon tetrachloride-containing reactant gas with a hydrogen-containing reactant gas in the hydrodechlorination reactor with a supply of heat to form a trichlorosilane-containing and HCl-containing product gas,
wherein:
the silicon tetrachloride-containing reactant gas, the hydrogen-containing reactant gas, or both, are introduced as pressurized streams into the hydrodechlorination reactor which is pressurized; and
the product gas is removed from the hydrodechlorination reactor as a pressurized stream.

3. The process of claim 2, wherein the silicon tetrachloride-containing reactant gas and the hydrogen-containing reactant gas are introduced as a combined stream into the pressurized hydrodechlorination reactor.

4. The process of claim 1, wherein the ceramic material is selected from the group consisting of Al₂O₃, AlN, Si₃N₄, SiCN and SiC.

5. The process of claim 4, wherein the ceramic material is selected from the group consisting of Si-infiltrated SiC, isostatically pressed SiC, isostatically hot-pressed SiC and SiC sintered under ambient pressure (SSiC).

6. The process of claim 1, wherein the reactor tube comprises SiC sintered under ambient pressure (SSiC).

7. The process of claim 2, wherein the silicon tetrachloride-containing reactant gas, the hydrogen-containing reactant gas, or both, are introduced into the hydrodechlorination reactor with a pressure in the range from 1 to 10 bar, and with a temperature in the range from 150° C. to 900° C.

8. The process of claim 1, wherein heat is supplied in the hydrodechlorination reactor by a heating space in which the reactor tube is arranged.

9. The process of claim 8, wherein the heating space is heated by electrical resistance heating or is a combustion chamber which is operated with a combustion gas and a combustion air.

10. The process of claim 1, wherein the reaction is catalysed by an inner coating which catalyses reaction in the reactor tube.

11. The process of claim 1, wherein the reaction is catalysed by a coating which catalyses reaction on a fixed bed arranged in the hydrodechlorination reactor or in reactor tube.

12. A process plant for preparing trichlorosilane, the process plant comprising a hydrodechlorination reactor, wherein the hydrodechlorination reactor is operated under pressure and comprises a reactor tube comprising a ceramic material.

13. The process plant of claim 12, comprising:
a) a component plant a) for reacting silicon tetrachloride with hydrogen to form trichlorosilane, comprising:
a hydrodechlorination reactor arranged in a heating space or a combustion chamber;
a first line for introducing a silicon tetrachloride-containing gas and a second line for introducing a hydrogen-containing gas, which lead into the hydrodechlorination reactor, such that a combined line for introducing the silicon tetrachloride-containing gas and the hydrogen-containing gas is optionally provided instead of the first line and the second line;
a third line conducted out of the hydrodechlorination reactor for removing a trichlorosilane-containing and HCl-containing product gas;
a heat exchanger through which the third line and the first line, the second line, or both, are conducted such that heat transfer from the third line into the first line, the second line, or both, occurs, such that the heat exchanger optionally comprises heat exchanger elements made from a ceramic heat exchange material;
optionally a removal component plant or an arrangement comprising a plurality of removal component plants for removing in each case one or more products comprising silicon tetrachloride, trichlorosilane, hydrogen and HCl;
optionally a fourth line which conducts silicon tetrachloride removed from the hydrodechlorination reactor into the first line;
optionally a fifth line for feeding trichlorosilane removed from the hydrodechlorination reactor to an end product removal process;
optionally a sixth line which conducts hydrogen removed from the hydrodechlorination reactor into the second line; and
optionally a seventh line for feeding HCl removed from the hydrodechlorination reactor to a plant for hydrochlorinating silicon; and
b) a component plant b) for reacting metallurgical silicon with HCl to form silicon tetrachloride, comprising:
a hydrochlorination plant connected upstream of the component plant a), optionally receiving at least a portion of the HCl removed from the hydrodechlorination reactor through the seventh line;
a condenser for removing at least a portion of a hydrogen coproduct which originates from reaction in the hydrochlorination plant, wherein the hydrogen coproduct is directed through the second line into the hydrodechlorination reactor;
a distillation plant for removing at least silicon tetrachloride and trichlorosilane from a remaining product mixture which originates from the reaction in the hydrochlorination plant, said silicon tetrachloride is conducted through the first line into the hydrodechlorination reactor;
optionally a recuperator for preheating combustion air intended for the combustion chamber with a the flue gas flowing out of the combustion chamber; and
optionally a steam plant for generating steam from the flue gas flowing out of the recuperator.

14. The process plant of claim 12, wherein the ceramic material is selected from the group consisting of Si-infiltrated SiC, isostatically pressed SiC, isostatically hot-pressed SiC and SiC sintered under ambient pressure (SSiC).

15. The process plant of claim 13, which is suitable for the process of claim 1.

16. A reactor tube, comprising a ceramic material selected from the group consisting of Al₂O₃, AlN, Si₃N₄, SiCN and SiC

17. The reactor tube of claim 16, which is suitable for reacting silicon tetrachloride with hydrogen in a hydrodechlorination reactor to give trichlorosilane.

18. The process of claim 1, wherein reactor tube consists of a ceramic material.

19. The process of claim 1, wherein the reactor tube consists of SiC sintered under ambient pressure (SSiC).

20. The process of claim 12, wherein the reactor tube consists of a ceramic material.
